(19) United States
(12) Patent Application Publication
(10) Pub. No.: US 2014/0100491 A1
(43) Pub. Date: Apr. 10, 2014

(54) Lower Extremity Robotic Rehabilitation System

(71) Applicants: Jianjuen Hu, Boxborough, MA (US); Yi-Je Lim, Boxborough, MA (US); Paolo Bonato, Somerville, MA (US); Jienan Ding, Watertown, MA (US)

(72) Inventors: Jianjuen Hu, Boxborough, MA (US); Yi-Je Lim, Boxborough, MA (US); Paolo Bonato, Somerville, MA (US); Jienan Ding, Watertown, MA (US)

(21) Appl. No.: 13/646,368

(22) Filed: Oct. 5, 2012

(51) Int. Cl. A61H 3/00; A61H 1/00

(52) U.S. Cl. CPC A61H 3/008; A61H 1/00; A61H 3/00
USPC 601/27; 601/35; 601/23

(57) ABSTRACT

To achieve “ecological” robotic rehabilitation therapy, the present invention provides the system capacity of training of patients in different ambulatory tasks utilizing motorized footplates that guide the lower limbs according to human gait trajectories generated for different ambulatory tasks of interest. A lower extremity robotic rehabilitation system comprises an active pelvic/hip device which applies series elastic actuation to achieve an intrinsically safe and desirable impedance control. A robotic unit features the telepresence operation control that allows a patient stay at home or nursing home to continue his or her rehabilitation training under a physician's remote supervision and monitoring. The robot unit utilizes an affective patient-robot interface to capture emotional information of the patient, to allow for real-time adaptation of the robotic system and adjustments of treatment protocol, and to enhance the quality and effectiveness of rehabilitation

### CROSS-REFERENCE TO RELATED APPLICATIONS

The present Utility patent application claims priority benefit of the U.S. provisional application for patent Ser. No. 61/573,359 filed on Sep. 6, 2011 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

This patent is partially developed through US Army SBIR Phase II Project under Contract W81XWH-09-C-0008 with project title: An Integrated Physical Therapy/Rehabilitation Robotic System for Military Healthcare Enhancement.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to robots. More particularly, one or more embodiments of the invention relate to medical rehabilitation robots.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a robot is a mechanical or intelligent agent that can perform tasks automatically or with guidance, typically by remote supervision. In practice a robot is usually an electro-mechanical machine that is controlled by means of computer and electronic programming. By automating movements, a robot may convey a sense that it has intent or agency of its own. More importantly, a robot working with rehabilitation patients should have an intrinsically safe actuation and be able to cooperate with humans safely.

Typically, a wide range of gait rehabilitation solutions have evolved to achieve motor gains through rehabilitation interventions.

The implementation of rehabilitation interventions using traditional approaches (e.g. manual gait training) based on a one-on-one interaction between therapist and patient is challenging given the shortage of rehabilitation specialists and the costs associated with performing a large number of repetitive rehabilitation sessions as required when an aggressive rehabilitation strategy is adopted. Technologies are needed to deliver rehabilitation interventions marked by high intensity and specificity of training with the objective of achieving optimal functional outcomes that would not be possible if we relied on traditional rehabilitation techniques.

Robotic technology allows therapist to avoid the physical work load associated with manually-assisted gait training and better concentrate on achieving good quality of movement or motion training. In other terms, the robot “replaces the hands of the therapist” who can therefore focus on guidance, supervision and fine-tuning the intervention by modifying, for instance, the amount of assistance provided by the robot to the subject and encourage the patient to actively and properly control joint movements.

A very limited number of studies have focused on designing robotic systems in a way that is fully suitable to meet the challenges encountered by clinicians in carrying out rehabilitation interventions. This invention includes motorized foot-plates with force feedback and an exoskeleton to control the movement of the pelvis during gait training to provide an ideal platform to implement ecologically-sound protocols that properly mimic real-life conditions and therefore achieve the goal of maximizing motor gains in stroke survivors. A unique combination of an active pelvic device with non-treadmill pedal system is required to further enhance the quality of rehabilitation to improve outcomes through progressive training procedures.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary lower extremity rehabilitation robotic system framework that is positioned so a patient can use the system for various rehabilitation protocols, standing, walking, and stair climbing;

FIG. 2 illustrates a non-treadmill haptic feedback pedal system with 8 degrees of freedom (DOF) total for lower extremity rehabilitation training;

FIG. 3 illustrates a detailed pedal-based system with 4 different DOF actuation mechanisms;

FIG. 4a illustrates a detailed view of the lower-limb rehabilitation system foot pedal belt-drive mechanism and motor for the X-direction linear actuation;

FIGS. 4b and 4c illustrate a detailed view of the lower-limb rehabilitation foot pedal system design for the Y- and Z-axis DOF, respectively;

FIG. 4d illustrates a detailed view of the lower-limb rehabilitation foot pedal system design for the theta-axis DOF;

FIG. 4e illustrates the theta-axis DOF mechanism with the belt drive, low-backlash high-torque harmonic drive, and servo motor to drive one side of the foot pedal through a high-breaking strength synchronous belt drive;

FIGS. 5a and 5b illustrate the haptic feedback foot plate mechanism with 6-DOF force sensor and the adjustable foot enclosure on the foot pedal;

FIG. 6 illustrates an exemplary assembled lower-limb rehabilitation foot pedal system including X-axis timing belt, chain-tensioner, pulley, chain-mounting, Oldham coupling, and the theta-axis pedal design;

FIG. 7 illustrates the frame assembly for pelvis rehabilitation system;

FIGS. 8a and 8b illustrate an exemplary body weight support system design for lower-limb rehabilitation, comprised of a consistent weight support suspension system (compliance) to accommodate for the vertical (Z) and horizontal (Y) displacement from the center of gravity that occurs during gait training;

FIG. 9 illustrates a detailed pelvic sub-assembly including a Series Elastic Actuator-based hip flexion/extension DOF, a hip size adjust mechanism, a compliant active pelvic obliquity DOF, and a belt-driven hip rotation DOF;

FIG. 10 illustrates a detailed carriage sub-assembly comprised of a SEA-based vertical DOF assembly, a passive horizontal DOF, a SEA-based pelvic obliquity, and linear absolute encoders;

FIG. 11 illustrates an exemplary assembled model of the pelvic sub-assembly and the vertical DOF carriage sub-assembly;

FIG. 12 illustrates the vertical shaft support structure for the vertical DOF carriage assembly comprised of steel linear support bearing shafts, upper and lower locating and support plates, ball screw and spring support through additional shafts, a linear absolute encoder strip, and a Z-direction motor;

FIG. 13 illustrates the dynamic patient weight support system for patient support consisting of the vertical DOF carriage assembly, vertical shaft support structure, pelvis sub-assembly, and the retention cord suspension mechanism for pelvic rehabilitation device;

FIGS. 14a and 14b illustrate the full dynamic patient weight support system including the foot pedals and pelvis stability mechanisms;

FIG. 15 illustrates an exemplary overall framework design of the lower extremity rehabilitation robotic system including foot pedals and an active pelvic device for natural and ecological gait training;

FIGS. 16a and 16b illustrate an exemplary overall framework design of the two stage steppers for the patient to easily step on the rehabilitation robotic system foot pedals;

FIG. 17 illustrates an exemplary implementation of impedance controller using a force signal for non-treadmill foot pedal gait training device;

FIG. 18a illustrates the overall physiological data-based affective state modeling process; (the affect-sensitive human-robot interaction (AS-HRI) module architecture to more accurately model a user's cognitive abilities to predict their behavior and provide accurate information to the other modules within the rehabilitation robotic system)

FIG. 18b illustrates the affective agents module which collects and records the physiological signals from the patient engaged in some task are and then processed to determine the affective state of the subject;

FIG. 19 illustrates exemplary operation modes of the present invention in which the remote physical therapist observes and interfaces with patient physiological data on the physical therapist's PC to provides intelligent feedback and direct rehabilitation operation and a local physical therapist runs under the direct monitoring.

FIG. 20 illustrates a typical computer system that, when appropriately configured or designed, can serve as a computer system in which the invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

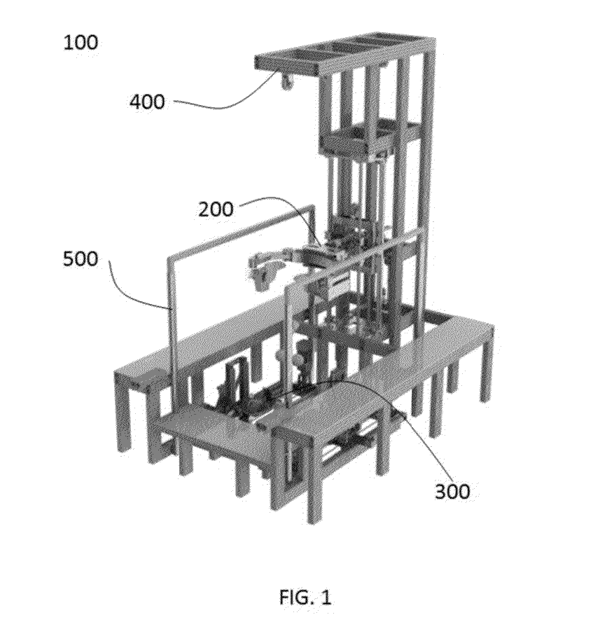

FIGS. 1 through 20 illustrate some exemplary embodiments and various views of a lower extremity robotic rehabilitation system and numerous components of the robotic system, in accordance with at least one embodiment of the present invention. One embodiment of the present invention may include a rehabilitation robotic system that services a patient in a medical rehabilitation facility or at a remote site. The rehabilitation robotic system may service a patient by delivering rehabilitation protocols based on repetitive motor tasks with the assistance of a physical therapist. Such protocols are known to cause neural adaptations leading to regaining motor function. An integrated and reconfigurable rehabilitation robot system that allows the implementation of multiple training procedures will further enhance the quality of rehabilitation. A computer-controlled rehabilitation robot can help improve patient outcome through progressive training procedures, advanced sensing, procedure optimization and remote supervision.

FIG. 1 illustrates an exemplary rehabilitation robotic system framework that is positioned so a patient can use the system for various rehabilitation protocols. In the embodiment shown (100), the framework includes a non-treadmill haptic feedback foot pedal-based system (300), a pelvis rehabilitation device (200), a body weight support system comprised of a pulley system for a body harness (400), and a set of parallel bars for arm support (500). The framework of the rehabilitation robotic system provides enhanced rehabilitation training quality and efficiency for patients with neurological and muscular injuries or functional impairments. This system also relieves physical therapists from the burden of heavy, labor-intensive training techniques. Instead, it allows the physical therapist to focus on the assisting the patient into the system and choosing the controlled ambulatory activity and settings for a training session.

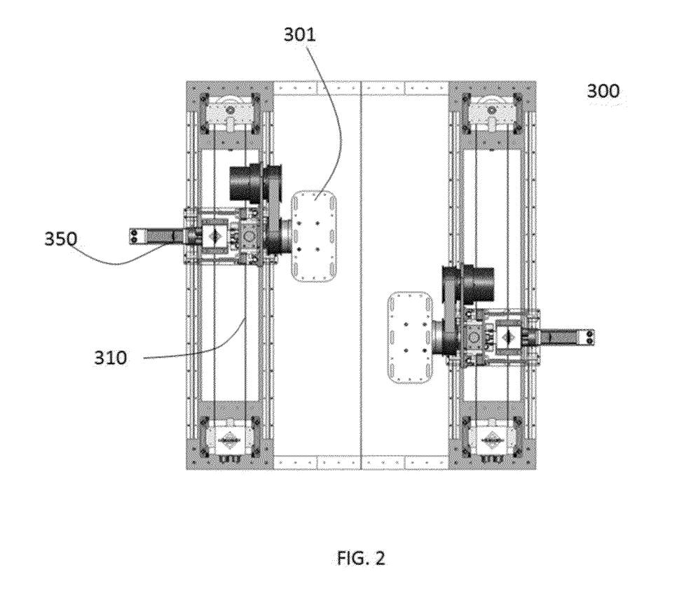

FIG. 2 illustrates a top-down view of the foot pedal-based lower rehabilitation system (300) with 8 DOF. The present embodiment displays the foot pedal (301), its X- (310), and Y-actuation (350) mechanism. The present embodiment uses a chain drive for X-axis actuation transmission.

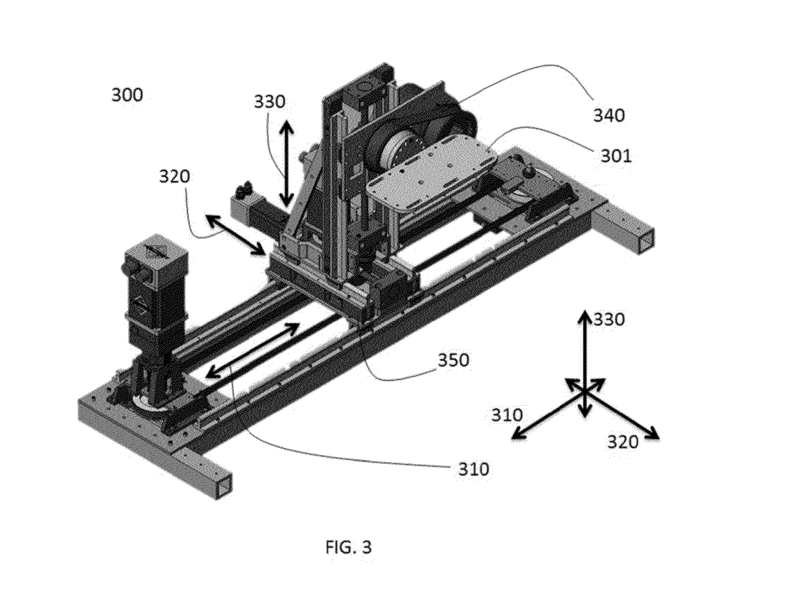

FIG. 3 illustrates one side of the foot pedal system (300) for one foot. The present embodiment design employs a chain (or belt) drive in the X-direction (310), the direction of normal gait, to achieve acceptable walking speed, includes a degree of freedom in the Y-direction (320), and incorporates an arm to accomplish Z-direction motion (330) to remove bulky components from the proximity of the user's foot. It also includes the theta degree of freedom (340) for adjusting the angle of the ankle near the foot pedal (301). Furthermore, the pedal actuation mechanism (350) is shown in more detail in this embodiment.

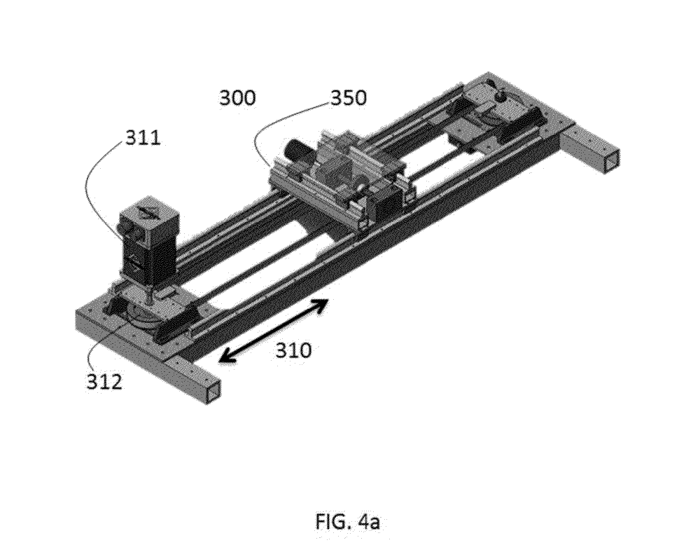

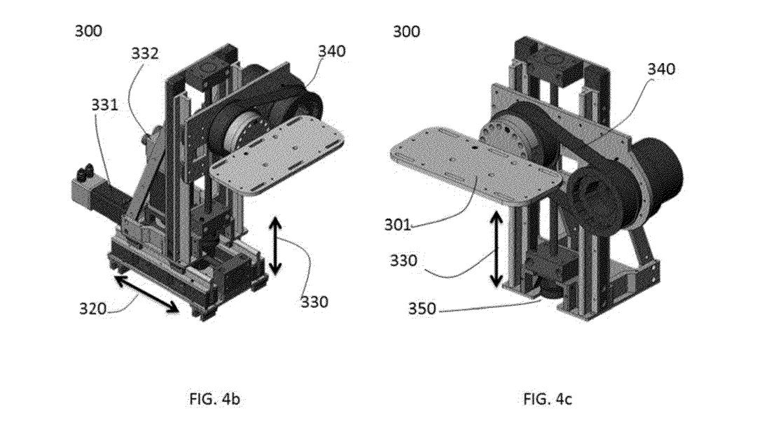

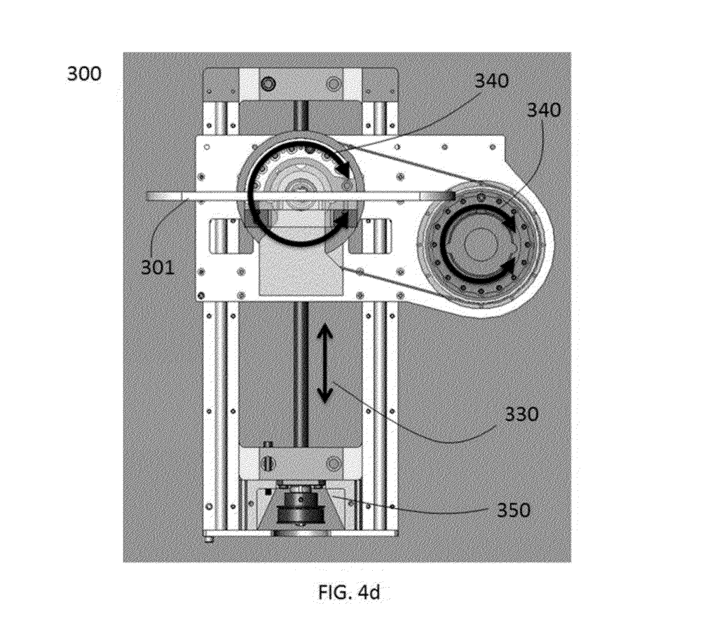

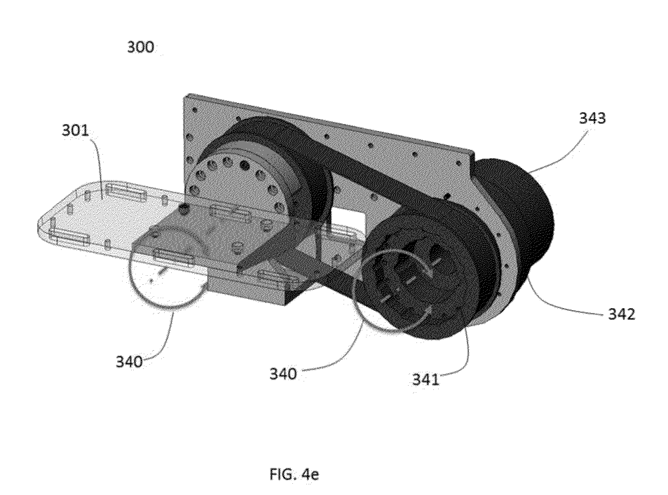

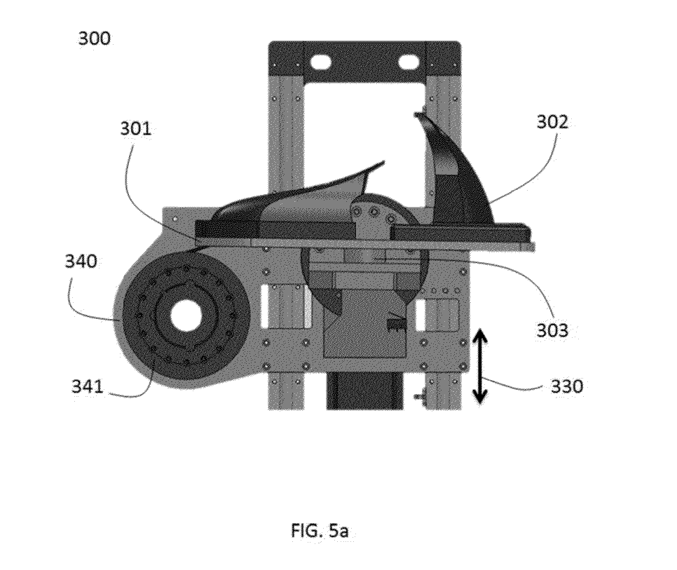

FIGS. 4a, 4b, and 4c illustrate the present embodiment design of the foot pedal mechanism with four DOF for each foot. A chain (or belt) drive mechanism is utilized to achieve the desired speed and strength requirements for accurate gait training FIG. 4a illustrates the embodiment's X-direction (310) chain (or belt) drive mechanism (312) with the X-direction motor (311). FIG. 4b illustrates the Y-direction ball screw mechanism (320) and its actuation motor (331). FIG. 4c illustrates the embodiment's Z-direction (330) ball screw mechanism and motor (332).

FIG. 4d illustrates a detailed view of the theta-axis DOF design embodiment (340) of the foot pedal with relation to the Z-direction (330) actuation mechanism.

FIG. 4e illustrates a detailed view of the theta-axis DOF mechanism of the foot pedal including the offset belt drive (341), low-backlash high-torque harmonic drive (342), and a servo actuator motor (343) to drive one side of the foot pedal with the belt drive.

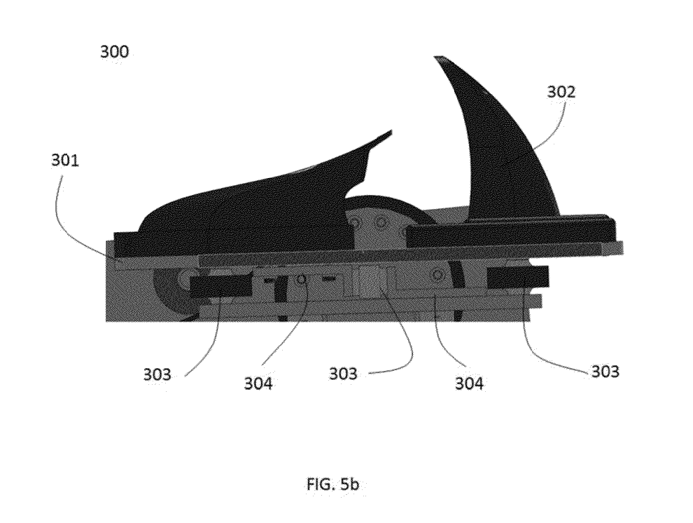

FIG. 5a illustrates the adjustable pedal foot enclosure (302) and an integrated 6-axis load cell (303) underneath the foot pedal mechanism to measure patient kinetics. The 6-axis load cell (303) makes use of the foot pedal haptic feedback sensory unit by measuring force and torque. This present embodiment allows the rehabilitation specialist to measure an individual's exerted loads and torques with a six-axis small load cell (303) in six axes for force feedback impedance control. And with the applied loads and kinematics, the individual joint torques and powers can be back-calculated from the sensor-human interface, yielding an understanding of improvements or deficiencies in joint performance.

FIG. 5b illustrates an exemplary embodiment of three cost effective 1-DOF load cells for measuring the most dominant Fx, Fz, and torque for force feedback control. The present invention decouples the foot pedal and load cell mounting brackets in order to measure forces and torque accurately with three individual 1-Axis force sensors. Two 1-DOF force sensors are mounted underneath of the foot plate to measure Fz and Torque, and a 1-DOF force sensor is placed between two brackets (304) which are designed to decouple its X-directional movement from Z-axis motion.

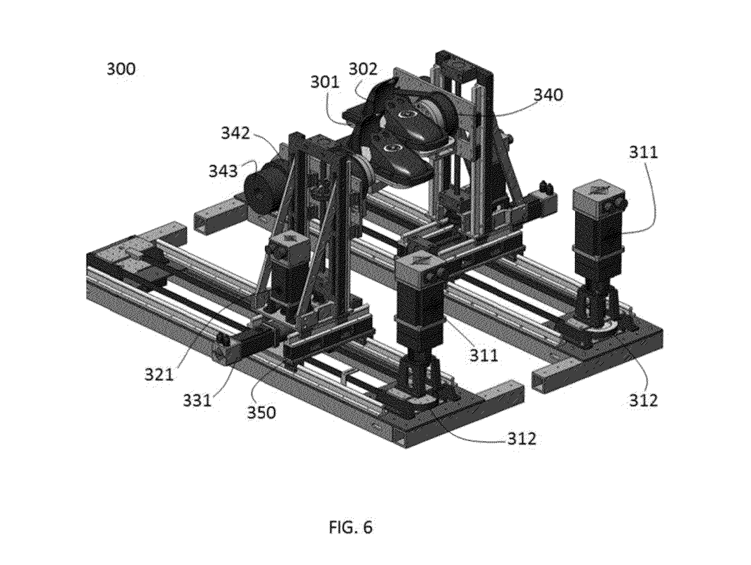

FIG. 6 illustrates an exemplary lower-limb rehabilitation foot pedal system assembly (300). Due to the non-treadmill lower rehab device, the patient is allowed to retrain ambulating on different terrains—flat ground surfaces with variable compliance/stiffness, uneven ground surfaces, stair descending/ascending, ramp road descending/ascending, etc. The present invention is an end-effector type of lower extremity gait training which is well suited for patient-cooperative control strategies. As patients undergo the training procedure, they will be presented with different ambulatory tasks accordingly and the robot will guide them to make transitions from level walking to stair ambulation or ramp ambulation as needed. While training different gait training sessions, patients change their gait kinematics notably. Interaction torques the between patient pelvic/hip/foot and robot will be significantly different under the different training conditions. This capability will allow the patient evolvement and engagement in the training.

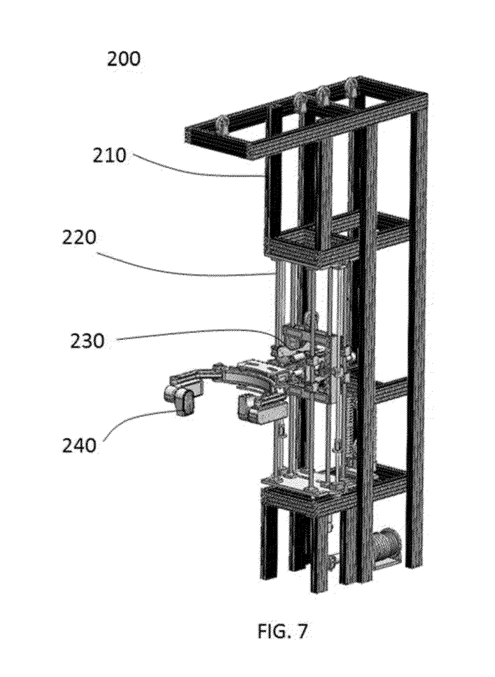

FIG. 7 illustrates the sub-assembly for the pelvis and body weight support system for lower-limb rehabilitation (200). The components of this sub-assembly include the frame (210), the vertical support structure (220), the vertical DOF carriage assembly (230), and the pelvis sub-assembly (240).

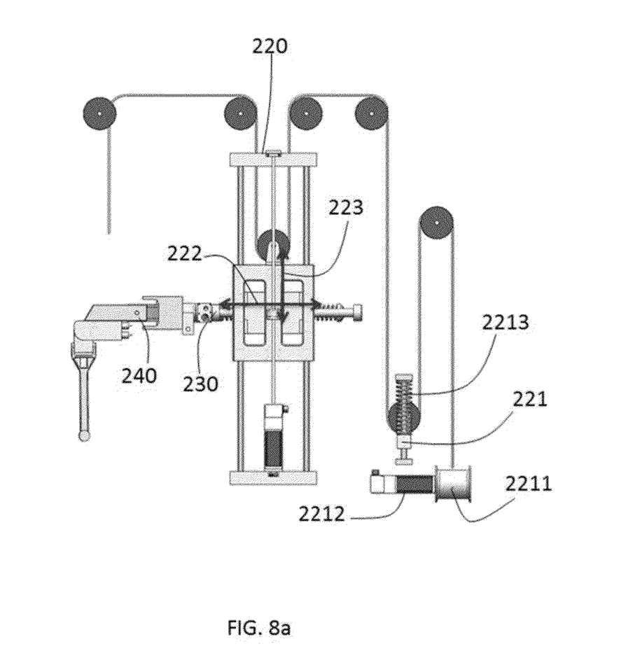

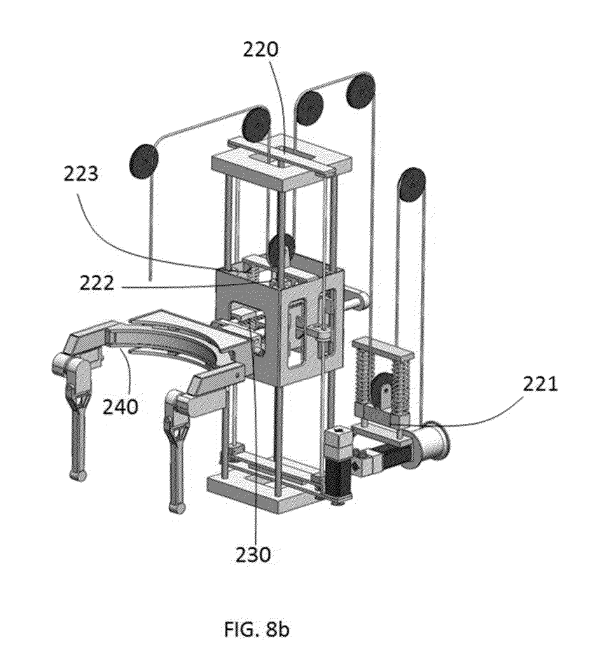

FIGS. 8a and 8b illustrate an exemplary body weight support system design for lower-limb rehabilitation, in which the embodiment is comprised of a consistent weight support suspension system with compliance to accommodate for the vertical (Z) (223) and horizontal (Y) (222) displacement from the center of gravity. Compliance at each robot joint allows the robot to act safely with patient. Compliance also allows a manipulator to adapt to positioning errors resulting from perceptual uncertainty, to limit restoration forces caused by these errors, and to improve contact stability. In manipulation, compliance is often achieved through active impedance control, where the controller maintains a desired force-velocity relationship at the end-effector via velocity or force sensors. Because rehabilitation patients are often not capable of maintaining their equilibrium at the start of the rehabilitation process, body weight support systems can be employed to assist them. The patient attachment for weight support transmits forces from the lower extremity rehabilitation robotic system to the patient. A suitable attachment should be comfortable, highly adjustable, fast to don/doff, and relatively stiff in the actuated DOF. A parachute harness fits these requirements and is available in multiple sizes. Also, a robotic body weight support system can provide forced movement to shift the body in order to simulate proper movement patterns with position control. This position-controlled system guides movement and, in some cases, resists unwanted movement. This device also provides pelvic stabilization by utilizing retention cords, shown in the present embodiment, to attach to special attachment rings on the back of the support vest or harness, secured to the frame, and adjusted for the desired degree of pelvic stabilization.

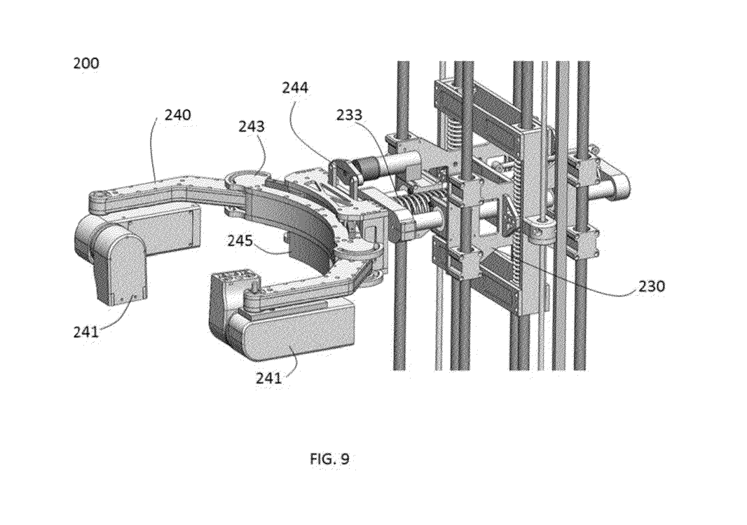

FIG. 9 illustrates a detailed embodiment of the pelvic sub-assembly (240) of the pelvis rehabilitation system (200) including a SEA-based hip flexion/extension DOF (241), a hip size adjust mechanism (243), a compliant pelvic obliquity DOF (244), and a belt-driven hip rotation DOF (245). This sub-assembly is critical in addressing natural pelvic rotation when gait training. The robotic rehabilitation pelvic sub-assembly addresses pelvic rotation when walking.

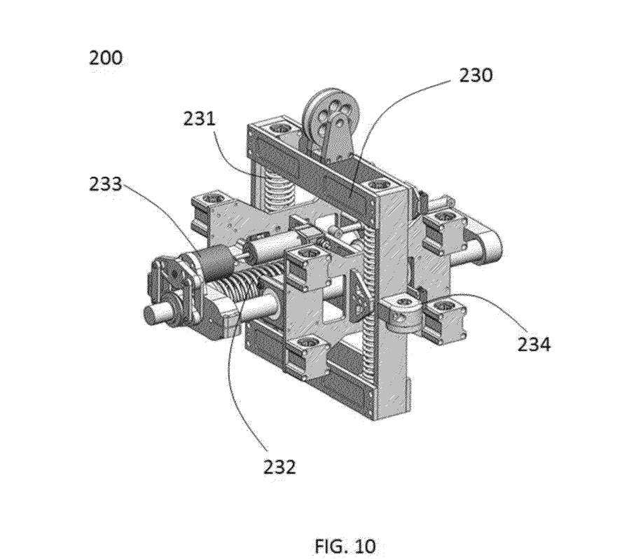

FIG. 10 illustrates a detailed embodiment of the vertical DOF carriage sub-assembly (230) comprised of a vertical DOF sub-assembly (231) and a passive translation DOF (232). The vertical carriage sub-assembly uses four springs and linear absolute encoders (234), actuated by a ball-screw and tied to the patient body weight support system. A passive horizontal DOF (232) will use two springs that are attached to the pelvic sub-assembly and its position will be sensed by linear potentiometers. The vertical DOF carriage assembly also includes a SEA-based pelvic obliquity DOF (233) that uses a four bar linkage and actuated by a motor and gear-head. An absolute rotary encoder provides position feedback, and either a potentiometer or another absolute encoder can be used for compliance sensing.

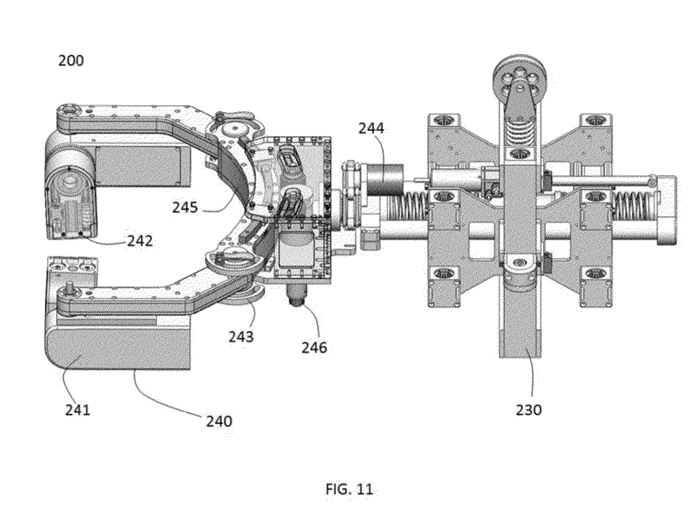

FIG. 11 illustrates an exemplary assembled design of the pelvic sub-assembly (240) and the vertical DOF carriage sub-assembly embodiment (230), without the vertical shaft support structure (220). The pelvis/hip assembly includes three active DOFs, pelvis rotation, pelvic obliquity, and hip flexion/extension. This device should support part of the patient's weight and the weight shift from stance leg to swing leg. Pelvic rotation occurs when the hips move frontally relative to each other. Actuating pelvic rotation allows some control of the swing legs without using the hip- or knee joint muscles. Pelvis rotation DOF is recognized in the advanced rehabilitation robotic system by upper pelvis assembly rotation relative to the lower pelvis assembly, and about the centerline of the torso. This degree is adjustable based on patient size and body type by adjusting the additional patient harness.

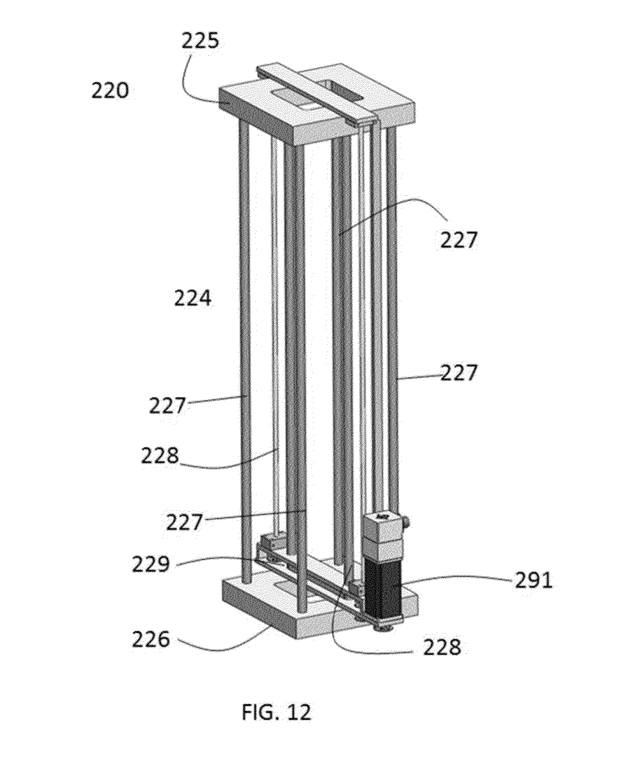

FIG. 12 illustrates the vertical support structure (220) in which the vertical DOF carriage sub-assembly embodiment (230) is positioned on. The support structure is comprised of stock steel linear bearing shafts (224), upper locating (225) and lower support (226) plates, four shafts for main support at the corners (227), a ball screw/spring support via additional shafts (228), a linear absolute encoder strip (229), and a Z-direction motor (291).

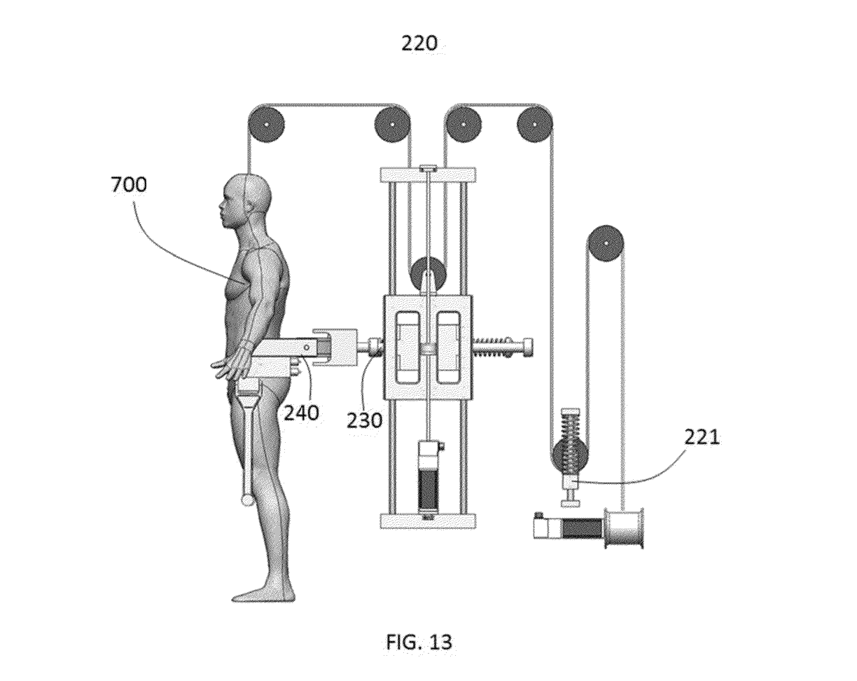

FIG. 13 illustrates the dynamic body weight and pelvis support system including the vertical DOF carriage sub-assembly embodiment (230), the pelvic sub-assembly (240), and the vertical support structure (220). The patient support system uses a pulley system with climbing rope, a motor actuator with brake used for winch, and measures tension by a spring system and linear absolute encoder (221).

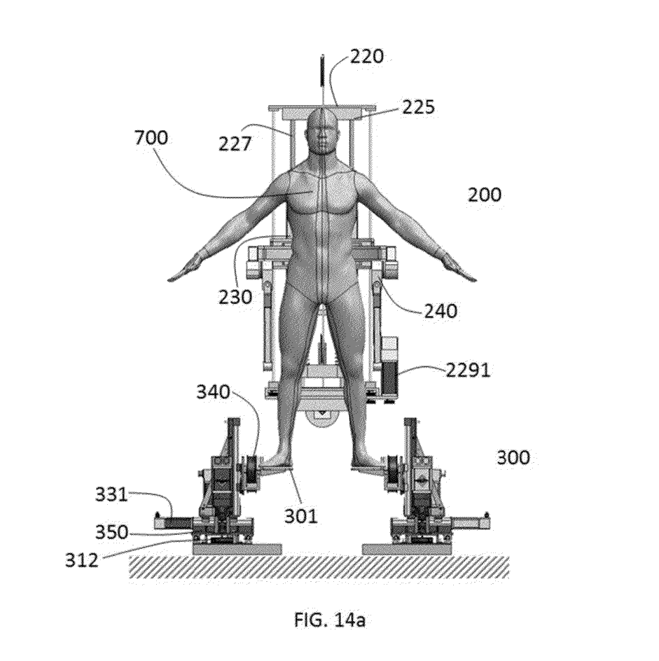

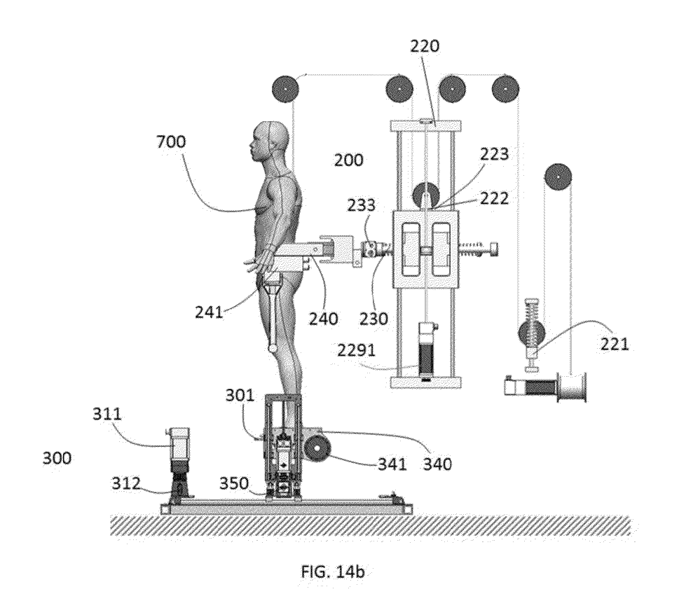

FIGS. 14a and 14b illustrate the pedal and pelvis system set-up/dynamic patient weight support system which includes the foot pedal (300) and pelvis support (200) rehabilitation systems as well as the body weight support system (220) for patient support during rehabilitation. These figures demonstrate how a human patient would be positioned in relationship to the entire rehabilitation system.

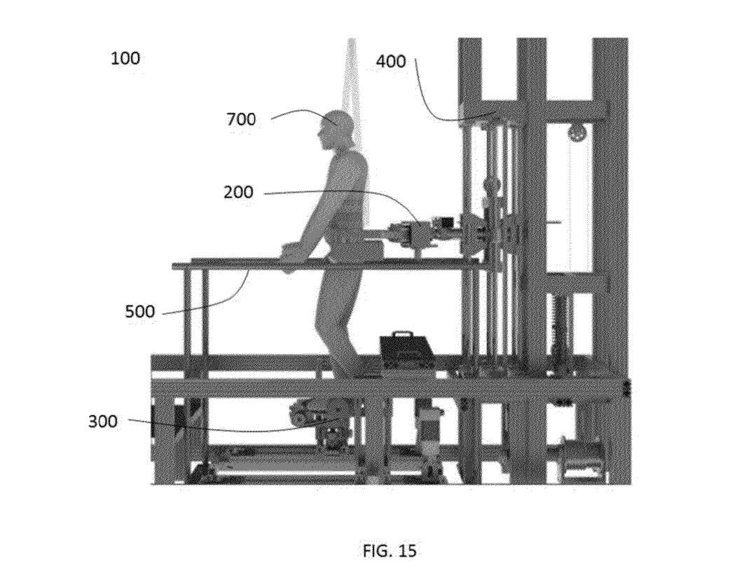

FIG. 15 illustrates an exemplary overall framework design of the lower extremity rehabilitation robotic system (100) that includes a foot pedal (300) and active pelvic device (200). The dynamic weight supporting device (400) is used for a more accurate gait pattern. This allows the patient to move naturally through rehabilitation. The weight supporting device (400) undulates back to neutral position after being translated. Then, the patient (700) can train for weight-bearing ambulation without compromising proper gait kinematics.

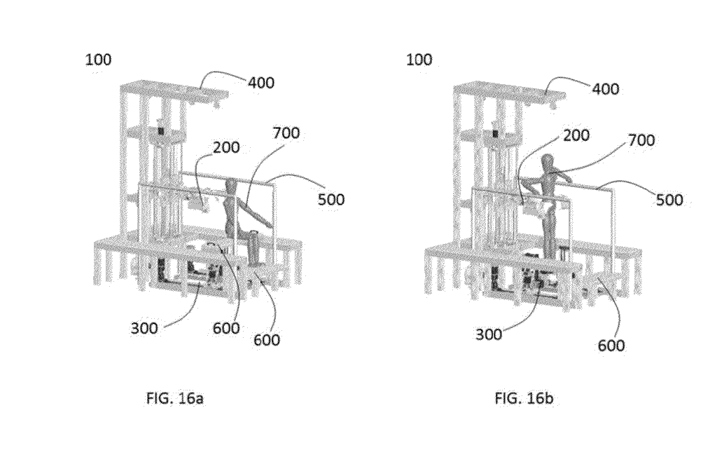

FIGS. 16a and FIG. 16b illustrate an exemplary overall framework design of the two stage steppers (600) for the patient (700) to easily step on the rehabilitation robotic system foot pedals. This present embodiment design provides an easily accessible system for a patient as well as for the assisting physical therapist or rehabilitation specialist.

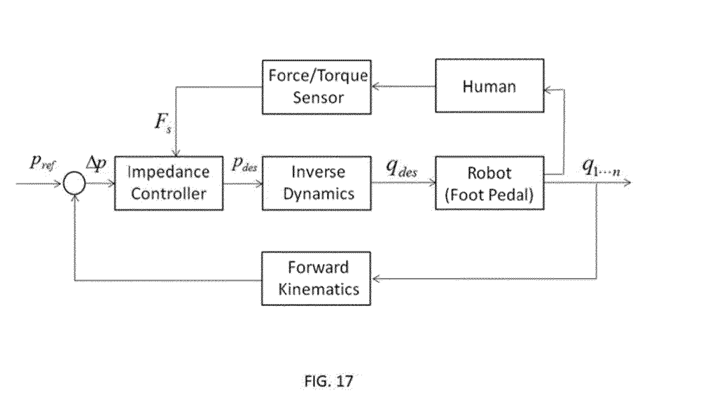

FIG. 17 illustrates an exemplary block diagram of the implementation of impedance controller. The force/torque sensor or SEA actuation is able to sense the interact force Fₛ between foot pedal and human foot and then send it to impedance controller module. Meanwhile, the encoders installed on foot pedals are measuring the pedal's joint angle in real time and feed it into the forward kinematics module to calculate robot's current position P_{cur}. Both robot current position P_{cur} and external force Fₛ are the two input of impedance controller and used to calculate the desired robot position P_{des}. Given the position P_{des}, the robot inverse kinematics can calculate the desired joint position g_{des} to move the robot. In this impedance controller, the therapist can change the reference position P_{ref} to adjust the gait trajectory and velocity. The therapist can also adjust the walking softness and hardness by changing the impedance model K. We will design an impedance controller for non-treadmill lower limb training system.

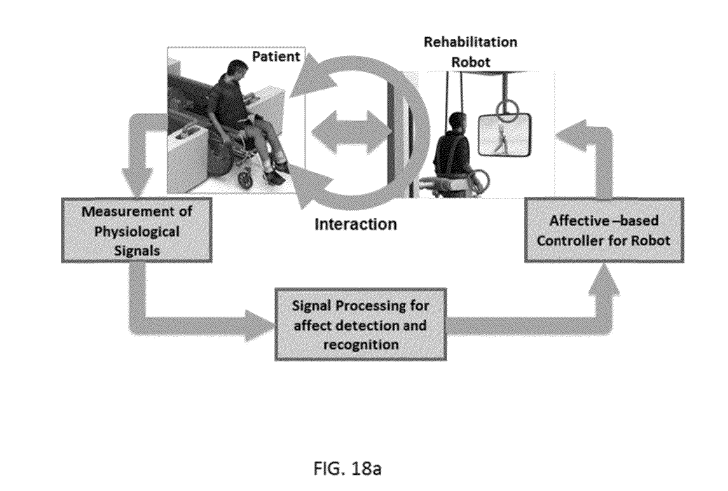

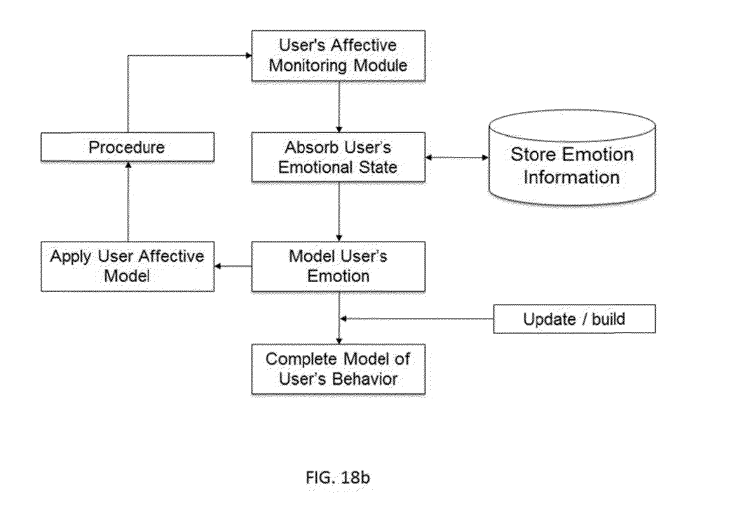

FIG. 18a illustrates an exemplary diagram of the affect-sensitive human-robot interaction architecture. The physiological signals from the patient engaged in some task are recorded and then processed to determine the affective state of the subject. The affective state information is used by a controller to decide the next course of action. The controller instructs the robot to perform the desired action. The subject who is interacting with the robot is then influenced by the robot's action.

FIG. 18b illustrates an exemplary block diagram of the affect-sensitive patient-robot interaction that provides the benefits of ‘one-on-one training’ within a highly interactive and engaging environment. This system first gathers information concerning the user's emotional state from the emotion monitoring, stores the patient's emotion information, builds a model of the user's emotional states, applies the user affect model to the applications and interface to customize the interaction between user and system, updates the user affect model to reflect the user's response patterns changing over time, and updates and build a more complete model of the user's behavior.

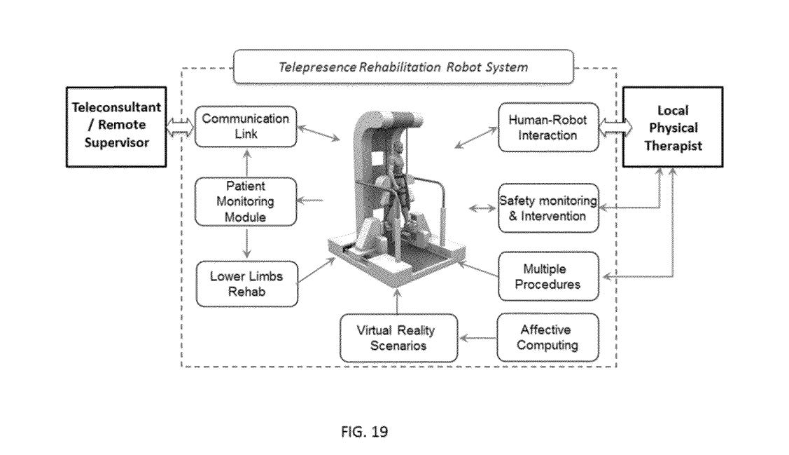

FIG. 19 illustrates an example block diagram of the telepresence rehabilitation robotic system. In order for the physical therapist or rehabilitation expert to remotely monitor patient rehabilitation status in a telepresence operation process, it is important to transmit video, audio, haptic sensing signals, and live patient rehabilitation training information through the communication network effectively. The present invention includes a teleoperation mode by accepting the control signals and commands from a remote supervisor, transmitted via the communication network. Haptic sensor information and rehabilitation process information is also sent to the remote supervisor for perception enhancement and effective teleconsultation. The data communication is sent and received is through an “http server.” The patient's rehabilitation sensor data is able to be displayed on a local or remote physical therapist's PC screen. It renders the scenes of the patient's rehabilitation training and provides intelligent feedback and data to the physical therapist. It also records rehabilitation data and stores it in a database.

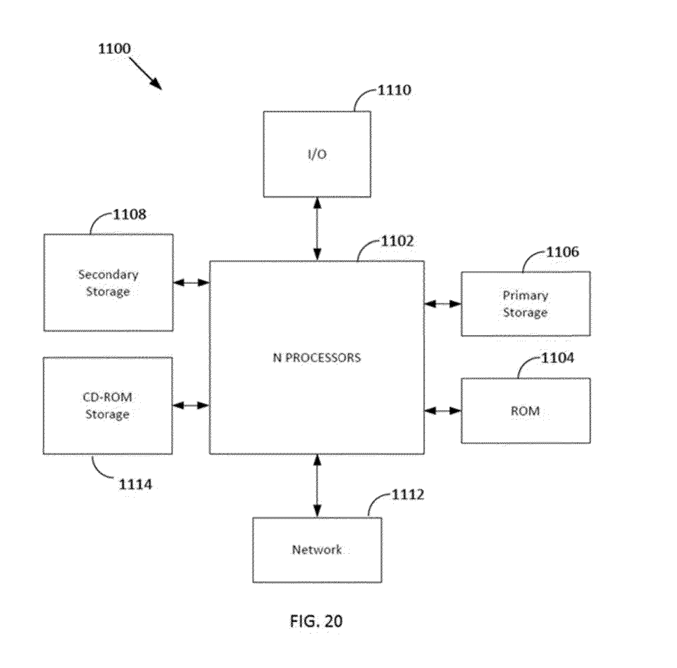

FIG. 20 illustrates a typical computer system that, when appropriately configured or designed, can serve as a computer system in which the invention may be embodied. The computer system 700 includes any number of processors 702 (also referred to as central processing units, or CPUs) that are coupled to storage devices including primary storage 706 (typically a random access memory, or RAM), primary storage 704 (typically a read only memory, or ROM). CPU 702 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 704 acts to transfer data and instructions uni-directionally to the CPU and primary storage 706 is used typically to transfer data and instructions in a bi-directional manner. Both of these primary storage devices may include any suitable computer-readable media such as those described above. A mass storage device 708 may also be coupled bi-directionally to CPU 702 and provides additional data storage capacity and may include any of the computer-readable media described above. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 may also be coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications or internet network using an external connection as shown generally at 712, which may be implemented as a hardwired or wireless communications link using suitable conventional technologies. With such a connection, it is contemplated that the CPU might receive information from the network, or might output information to the network in the course of performing the method steps described in the teachings of the present invention.

In the overall present embodiment, a physical therapist or rehabilitation specialist directs the rehabilitation robot system by selecting a specific rehabilitation procedure in the system computer interface. Unique characteristics of the lower extremity rehabilitation system are (1) the ability to train individuals to properly perform a variety of ambulatory tasks on different simulated terrains; (2) the simultaneous control of footplates and pelvis movements; (3) the ability to change the target trajectory utilized to train the patient; (4) the ability to provide feedback to the subject based on kinematic and/or kinetic parameters of ambulation; and (5) the ability to utilize sensor-based strategies to determine progress in the patient undergoing training within a session and across sessions. The developed procedures are essentially the same for all patient groups, with only marginal adaptations that are specific of the pathology and severity of the impairment and functional limitations associated with a given individual.

In some alternative embodiments, the rehabilitation robotic system allows patients to practice independently and to improve on their own functional level as the robot can assist, support or resist the desired action. Most of the robot-mediated therapy does not necessary require patient's own active movement as robot can assist the movement as required. Consequently, this system feature allows for rehabilitation in a remote location outside of a medical rehabilitation facility and allows for physical therapist or rehabilitation specialist telepresence operation.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing rehabilitation services to patients in a health care facility through an advanced rehabilitation robotic system according to the present invention will be apparent to those skilled in the art. Various aspects of the invention have been described above by way of illustration, and the specific embodiments disclosed are not intended to limit the invention to the particular forms disclosed. The particular implementation of the rehabilitation robotic system may vary depending upon the particular context or application. By way of example, and not limitation, the robotic system described in the foregoing were principally directed to assist a physical therapist or rehabilitation specialist with an injured patient's rehabilitation in a rehabilitation facility; however, similar techniques may instead be applied in a remote facility, communicating with the patient through a telepresence interface. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A robotic rehabilitation system comprising:
a non-treadmill foot pedal platform to guide the lower limbs for ambulatory rehabilitation;
a lower extremity exoskeleton structure for hip/pelvis rehabilitation training;
a body weight support system comprised of a pulley system for a body harness,
at least one controlling unit being configured to be operable for at least operating a non-treadmill haptic feedback foot pedal platform and a hip/pelvic rehabilitation device;
at least one physiological sensor to record a patient's affect status
a telepresence communication link for remote supervision;

2. The robotic rehabilitation system as recited in claim 1, in which said non-treadmill foot pedal platform is further configured for various rehabilitation protocols, such as standing, walking, balancing and stair climbing.

3. The robotic rehabilitation system as recited in claim 1, in which said non-treadmill foot pedal platform further comprises a plurality of foot plates, drive mechanism for each axis, and foot enclosures on the foot plate.

4. The robotic rehabilitation system as recited in claim 1, in which said non-treadmill foot pedal platform is further being joined to said safety device to stop a whole system safely.

5. The robotic rehabilitation system as recited in claim 2, in which said non-treadmill foot pedal platform utilizes force sensing for feedback control and/or feed forward control.

6. The lower extremity robotic rehabilitation system as recited in claim 2, further comprising means for adjusting a step size of gait.

7. The robotic rehabilitation system as recited in claim 1, in which said lower extremity exoskeleton structure further comprises active hip rotation mechanism, active or passive pelvic obliquity mechanism, and active hip flexion and extension drive mechanism.

8. The lower extremity exoskeleton structure as recited in claim 7, further joining to said supporting framework structure.

9. The lower extremity exoskeleton structure as recited in claim 8, in which said framework structure is further comprising the vertical support structure, the vertical movement carriage, and the passive horizontal movement spring structure.

10. The lower extremity exoskeleton structure as recited in claim 7, further comprising means for adjusting a hip/pelvic size to place the adult patient on the device.

11. The lower extremity exoskeleton structure as recited in claim 7, further comprising means for providing compliance to produce a safe human contact.

12. The robotic rehabilitation system as recited in claim 1, in which said body weight support system is further comprised of a pulley system, body harness, rope, tension measurement, and motor.

13. The body weight support system as recited in claim 12, further comprising means for providing pelvic stabilization by utilizing retention cord that is attached to the hip/pelvic rehabilitation device, secured to the frame, and adjusted for the desired position of hip/pelvic device.

14. The robotic rehabilitation system as recited in claim 1, in which said controlling unit is further operable for guiding foot plates and hip/pelvic rehabilitation device according to trajectories corresponding to the different ambulatory tasks of interest.

15. The robotic rehabilitation system as recited in claim 1, in which said controlling unit is further operable for supporting a patient weight.

16. The robotic rehabilitation system as recited in claim 1, in which said controlling unit is further operable for synchronizing the motion of foot platform and the hip/pelvic rehabilitation device in ambulatory rehabilitation training process.

17. The robotic rehabilitation system as recited in claim 1, in which said at least one physiological sensor is further operable for determining a patient emotion status.

18. The physiological sensor as recited in claim 17, further interfacing with a controller to adjust the next course of training level of activities.

19. The lower extremity robotic rehabilitation system as recited in claim 1, further comprising an interface for remote telepresence communication between a health care professional and the adult patient.

20. A robotic rehabilitation system comprising:
means for operating the lower extremity robotic rehabilitation system for a gait training;
means, being joined to said operating means, for imparting torque and movement; and
means, receiving said torque and movement, being configured for moving an adult patient's lower body.

21. The lower extremity robotic rehabilitation system as recited in claim 1, in which said non-treadmill foot plate platform is removable and capable to use it separately.

22. The lower extremity robotic rehabilitation system as recited in claim 1, in which said pelvic/hip rehabilitation device is removable and capable to use it separately.

23. The lower extremity robotic rehabilitation system as recited in claim 1, in which, gait trajectory control can be suitable for both amputee patients' and able body patients' rehabilitation training.
